(19) United States
(12) Patent Application Publication
(10) Pub. No.: US 2023/0004200 A1
(43) Pub. Date: Jan. 5, 2023

(54) BOARD DEVICE OF SINGLE BOARD COMPUTER

(71) Applicant: PORTWELL INC., New Taipei City (TW)

(72) Inventor: Yi-Nan Jiang, New Taipei City (TW)

(21) Appl. No.: 17/365,197

(22) Filed: Jul. 1, 2021

(51) Int. Cl. G06F 1/20; G06F 15/78

(52) U.S. Cl. CPC G06F 1/20; G06F 15/7803

(57) ABSTRACT

A board device of a single board computer includes a baseboard with front and back areas; at least one small outline dual in-line memory module installed in the front area; a processor frame installed in the front area and having a size of a LGA 1200 processor socket; a cooling module combined with the processor frame and installed in the front area and having a size of a cooling module of a LGA 2011 processor socket; and a bottom frame portion disposed in the back area. The four locking members are passed through the four board holes of the baseboard to lock the bottom frame portion and the cooling module to the baseboard. The four board holes have a hole distance complying with the hole distance specification of the four slots of the cooling module of the LGA 2011 processor socket.

### FIELD OF THE INVENTION

The present invention relates to a board device, and more particularly to the board device of a single board computer.

### BACKGROUND OF THE INVENTION

### 1. Description of the Related Art

With reference to FIG. 1 for a conventional single board computer (SBC), the single board computer includes: a cooling module having a cooling base with four locking members for locking the cooling base onto a baseboard; and a small outline dual in-line memory module (SO-DIMM) disposed on the baseboard and adjacent to the cooling module. The small outline dual in-line memory module, usually abbreviated as SO-DIMM or SODIMM, is a computer memory with integrated circuits. The SO-DIMM is similar to DIMM, but its volume is smaller and approximately equal to half of the size of the regular DIMM.

PCI Industrial Computer Manufacturers Group (PICMG) has been dedicated to the specification development and integration of computers and industrial equipment since its establishment. The main purpose of the PICMG is to provide a universal standard specification to related manufacturers. A single board computer (SBC) is a complete computer built on a single circuit board and includes one or more microprocessors, memories, input/output (I/O) devices and other functions required by a functional computer. For the single board computer, after the processor (CPU) is upgraded, the heat dissipation requirement increases, and the size of the cooling module after the corresponding upgrade increases. The entire group or the processor frame for receiving of the processor usually serves as a cooling base which is modularized and bundled to the single board computer. With reference to FIGS. 1 and 4 for the prior art and the present invention respectively, the first width W1 of the prior art is greater than the second width W2 of the present invention, because the position of locking the locking member beyond the position of the small outline dual in-line memory module (SO-DIMM) will damage the small outline dual in-line memory module (SO-DIMM), which will result in the situation of unable of locking the cooling base onto the baseboard of the single board computer after the upgrade.

The prior art is limited by different specifications of the PICMG products. Due to the limited layout space of the single board computer, the prior art has the drawback of unable to combine the cooling module easily.

### 2. Summary of the Invention

Therefore, it is a primary objective of the present invention to overcome the drawback of the prior art by providing a board device of a single board computer in order to support each other's applications, indirectly expand the scale of the entire market, while reducing R&D costs of the manufacturers, and expediting the time-to-market of the products.

To achieve the aforementioned and other objectives, the present invention discloses a board device of a single board computer, comprising: a baseboard, with a front area and a back area; at least one small outline dual in-line memory module, installed in the front area of the baseboard; a processor frame, installed in the front area of the baseboard, and having a size complying with the size specification of a LGA 1200 processor socket; and a cooling module, combined into the processor frame, and installed in the front area of the baseboard, and the cooling module having a size complying with the size of a corresponding cooling module of the LGA 2011 processor socket.

In an embodiment of the present invention, the board device of a single board computer further comprises a bottom frame portion disposed in the back area of the baseboard, wherein the baseboard has four board holes; the cooling module further comprises a cooling base, four seat holes formed at four inner corners of the cooling base respectively, and four locking members; each locking member is configured to be corresponding to each respective board hole, and each board hole of the baseboard is configured to be corresponsive to each respective seat hole of the cooling module; the four locking members are passed through the four corresponding board holes of the baseboard respectively for locking the bottom frame portion and the cooling module to the baseboard, and the hole distance of the four board holes complies with the specification of the hole distance of the four seat holes of the cooling module corresponding to the LGA 2011 processor socket.

In the board device of a single board computer in accordance with an embodiment of the present invention, the small outline dual in-line memory module further comprises: a memory card; and a slot formed in the front area of the baseboard, and the memory card is plugged into the slot.

In the board device of a single board computer in accordance with an embodiment of the present invention, the cooling module further comprises: a fin module, coupled to the cooling base; a fan, coupled to the fin module; and four springs and four washers; wherein each locking member is configured to be corresponsive to the respective spring and the respective washer, and passed through the respective spring and the respective washer and then through the respective seat hole and the respective board hole for elastically fixing the cooling module.

In the board device of a single board computer in accordance with an embodiment of the present invention, the small outline dual in-line memory module has a first edge disposed adjacent to the cooling base, and the locking members are provided for locking the cooling base in the front area of the baseboard, and a gap is formed between the cooling base and the first edge of the small outline dual in-line memory module.

In the board device of a single board computer in accordance with an embodiment of the present invention, the processor accommodated in the processor frame is attached to the cooling base through a first thermal conductive sheet, and a second thermal conductive sheet.

In the board device of a single board computer in accordance with an embodiment of the present invention, the bottom frame portion further comprises: a bottom frame member, with a hollow inner side, and having four locking holes; a cushion frame, with a hollow inner side, and having four through holes, and an end of each locking hole being configured to be corresponsive to the respective through hole and the respective locking hole; and four clips, installed between the baseboard and the cushion frame, wherein after each locking member is passed through the baseboard, each locking member is clamped by a clip, and after an end of each locking member is passed through the respective through hole, the locking member is configured to be corresponsive to the respective locking hole.

In the board device of a single board computer in accordance with an embodiment of the present invention, by a soldering hole of the baseboard, a lower end of the small outline dual in-line memory module is soldered to the back area of the baseboard, the locking members are provided for locking the bottom frame member to the back area of the baseboard, and a gap is formed between the bottom frame member and a soldering hole of the small outline dual in-line memory module.

The board device of a single board computer of the present invention overcomes the drawback of the prior art. Since the PICMG products are limited by their specification and with fixed height. When the conventional LGA 1200 processor socket and four pieces of SO-DIMM MEMORY are arranged parallel to one another, the conventional cooling module of the LGA 1200 processor socket has a size and shape has a conflict with the position for locking the locking member to the seat hole and the board hole, so as to interfere with the position of the SO-DIMM MEMORY, and the processor socket cannot be used. On the other hand, the present invention provides a board device of a single board computer and integrates the locking member of the cooling module with the LGA 2011 processor socket specification with the positions of locking to the seat holes and board holes and the single board computer (SBC) with the present existing LGA 1200 processor socket to create a novel board device of a single board computer in accordance with the present invention to achieve the effect of using the cooling module in various different processors. The invention overcomes the drawback of the conventional fixed way of using a processor with a cooling module by providing a board device of a single board computer, wherein the second width 56 mm of the cooling module complying with the existing LGA 2011 processor socket is smaller than the first width 75 mm of the cooling module complying with the LGA 1200 processor socket can save the design cost and the development time of a customized cooling module, and the invention can be applied immediately to various PICMG products of different specifications, so that the LGA 1200 processor socket operating with four SO-DIMM memories can be arranged parallel to each other on a single board computer (SBC). The present invention provides a cooling module operated with the LGA 2011 processor socket and can overcome the spatial layout issue of having a conflict between the conventional LGA 1200 processor socket operated with four SO-DIMM memories and the LGA 1200 processor socket operated with the cooling module on the single board computer (SBC).

### BRIEF DESCRIPTION OF THE DRAWINGS

FIG. 1 is a schematic view of a conventional single board computer;

FIG. 2 is an exploded view of a single board computer of the present invention;

FIG. 3 is a schematic view showing the position of a locking hole of a bottom frame member of the present invention;

FIG. 4 is a schematic view showing the interval between a locking member of a cooling module and a small outline dual in-line memory module of the present invention; and

FIG. 5 is a schematic view showing the backside position of a single board computer of the present invention.

### DESCRIPTION OF THE PREFERRED EMBODIMENTS

PCI Industrial Computer Manufacturers Group (PICMG) has been dedicated to the specification development and integration of computers and industrial equipment since its establishment. The main purpose of the PICMG is to provide a universal standard specification to related manufacturers. A backplane is group of parallel electrical connectors, and each pin of each connector is connected to another connector to form computer bus and used for connecting a plurality of printed circuits to produce the backbone of a complete computer system. The backplane uses plug-in cards for storage and processing. The single board computer is usually manufactured as a demonstration or development system used in an education system or used as an embedded computer controller. Many types of home computers or portable computers integrate all their functions on a single printed circuit.

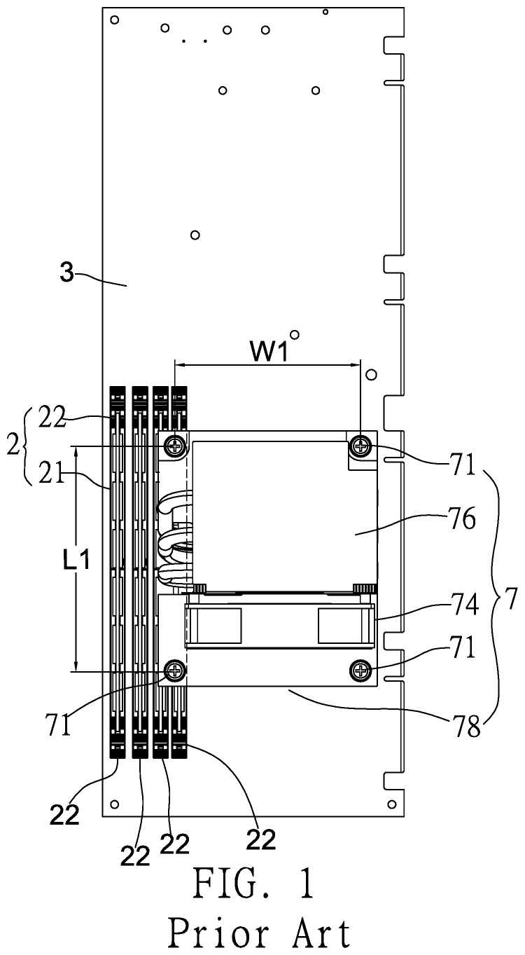

With reference to FIG. 1 for the prior art, a LGA 1200 processor socket bundled with four SO-DIMM memories is interfered by a LGA 1200 processor socket bundled with a cooling module 7, and spatial layout of the single board computer (SBC) has the following drawbacks. A small outline dual in-line memory module 2 is installed in a front area of a baseboard 3, and the small outline dual in-line memory module 2 has a memory card 21 and a slot 22, and the cooling module 7 is installed in the front area of the baseboard 3, and the cooling module 7 has a fan 74, a fin module 76, and a cooling base 78, wherein the locking member 71 is provided for locking the cooling base 78 to the baseboard 3. Although the first length L1 of the cooling base 78 is 75 mm, the first width W1 of the cooling base 78 is 75 mm, which is beyond the position of placing the four SO-DIMM memories, so that the size of the cooling base 78 will interfere with the four small outline dual in-line memory modules 2. The aforementioned LGA 1200 processor socket was announced by Intel in 2020 and used for processor sockets with Lomet Lake microarchitecture, and it supports processors such as Core i7, Corei9, etc.

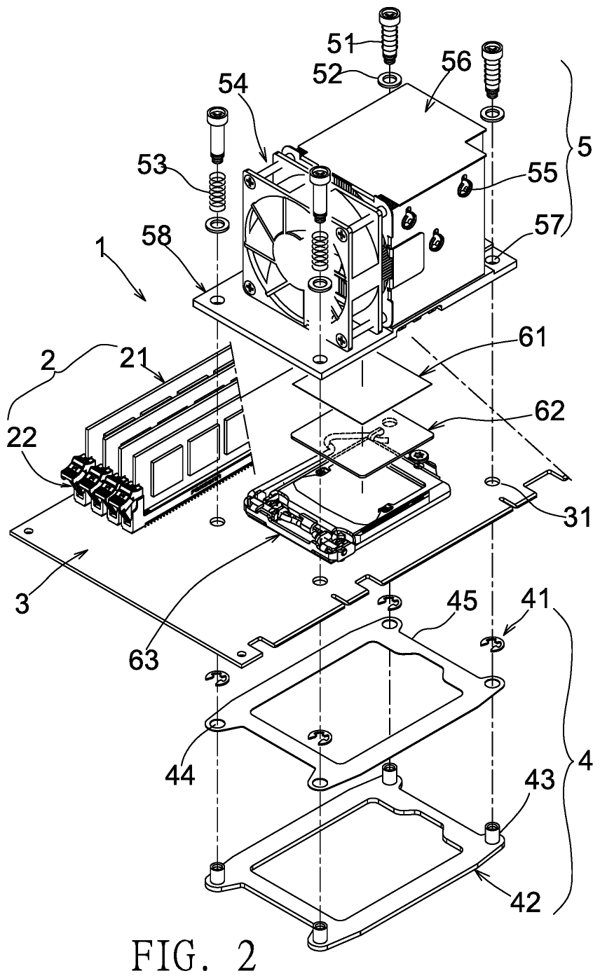

With reference to FIG. 2 for a board device of a single board computer 1 in accordance with an embodiment of the present invention, the board device of the single board computer 1 comprises: a baseboard 3 which is a motherboard, and the baseboard 3 having four board holes 31, and a front area and a back area; at least one small outline dual in-line memory module 2 installed in the front area of the baseboard 3; a processor frame 63 installed in the front area of the baseboard 3, wherein the processor frame 63 has a size specification complying with that of a LGA 1200 processor socket; a cooling module 5, combined into the processor frame 63 and installed in the front area of the baseboard 3, wherein the cooling module 5 has a size complying with the size of a cooling module corresponding to the LGA 2011 processor socket, and the cooling module 5 further comprises: a cooling base 58, having four seat holes 57 formed at four inner corners of the cooling base 58 respectively, and four locking members 51; and a bottom frame portion 4 disposed in the back area of the baseboard 3, wherein each locking member 51 is configured to be corresponsive to a board hole 31 of the baseboard 3, and each board hole 31 of the baseboard 3 is configured to be corresponsive to a seat hole 57 of the cooling module 5; the four locking members 51 are passed through the four corresponding board holes 31 of the baseboard 3 to lock the bottom frame portion 4 and the cooling module 5 to the baseboard 3, and the four board holes 31 have a hole distance complying with the hole distance specification of the four seat holes 57 of a cooling module of the corresponding LGA 2011 processor socket. The aforementioned LGA 2011 processor socket was announced by Intel in 2011 and for processor sockets of the Sandy Bridge microarchitecture.

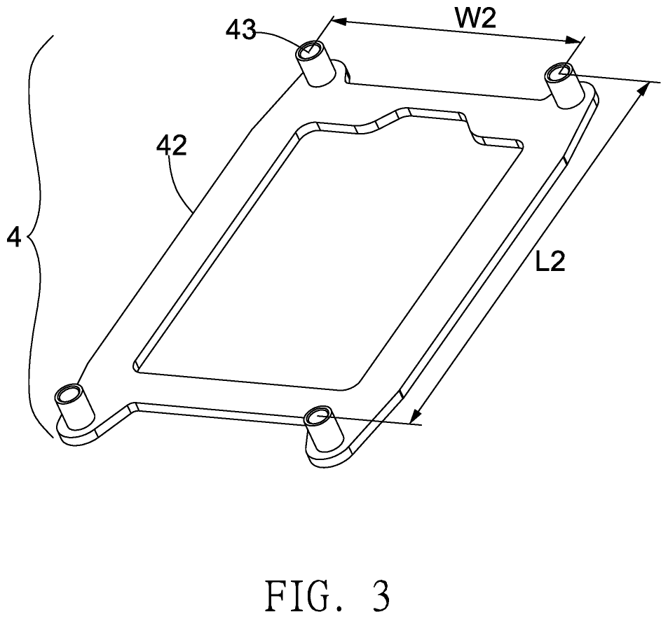

With reference to FIGS. 2, 3 and 4 for a board device of a single board computer 1 in accordance with an embodiment of the present invention, the small outline dual in-line memory module 2 further comprises: a memory card 21; and a slot 22 formed in the front area of the baseboard 3, and the memory card 21 is plugged into the slot 22; wherein after the back area of the slot 22 is passed through a soldering hole 221 at the back area of the baseboard 3 back area, the soldering hole 221 is soldered to the back area of the baseboard 3.

With reference to FIGS. 2, 3 and 4 for a board device of a single board computer 1 in accordance with an embodiment of the present invention, the cooling module 5 further comprises: a cooling base 58, having four seat holes 57 formed at four inner corners of the cooling base 58 respectively; a fin module 56, combined into the cooling base 58; a fan 54, coupled to the fin module 56; a plurality of heat dissipation holes 55 and four springs 53 and four washers 52; wherein each locking member 51 is configured to be corresponsive to a spring 53 and a washer 52; each locking member 51 is passed through the respective spring 53 and the respective washer 52 and then passed through the respective seat hole 57 and the respective board hole 31, for elastically fixing the cooling module 5.

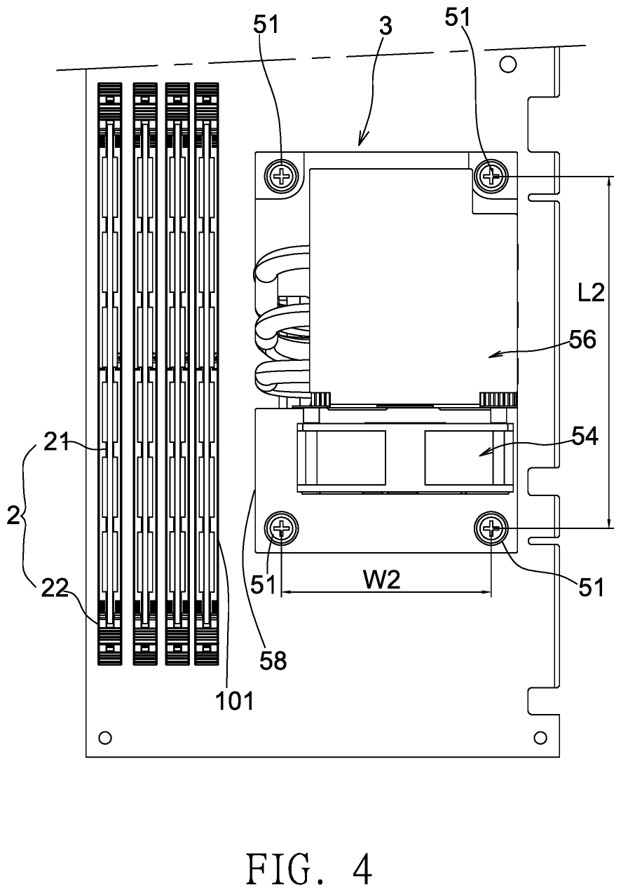

With reference to FIGS. 2, 3 and 4 for a board device of a single board computer 1 in accordance with an embodiment of the present invention, the small outline dual in-line memory module 2 has a first edge 101 adjacent to the cooling base 58, and the interval between the board holes 31 has a second length L2 and a second width W2, and the interval between the seat holes 57 has the second length L2 and the second width W2, and the edge between the board holes with the second length L2 is parallel to the first edge 101, and the edge between the board holes with the second width W2 is perpendicular to the first edge 101, and the locking members 51 are provided for locking the cooling base 58 to the front area of the baseboard 3, and a gap is formed between the cooling base 58 and the first edge 101 of the small outline dual in-line memory module 2. In the technical measure of the board device of the single board computer 1 of the present invention, the prior art as shown in FIG. 1 is compared with the present invention as shown in FIG. 4, wherein the cooling base 58 of the present invention has a second length L2 of 94 mm, but the cooling base 58 of the present invention has a second width W2 of 56 mm, which is smaller than 75 mm (the first width W1 of the cooling base 78 of the prior art). The invention can overcome the following drawback of the prior are. The first width W1 of the cooling base 78 is 75 mm, which is beyond the position of placing the four SO-DIMM memories, and the size of the cooling base 78 will interfere with the four small outline dual in-line memory modules 2. In FIG. 4, the present invention locks the cooling base 58 to the front area of the baseboard 3 and locks the cooling base 58 to the small outline dual in-line memory module 2 which is coupled to the first edge 101 of the front area of the baseboard 3. In the present invention, the size of the cooling base 58 will not interfere with the four small outline dual in-line memory modules 2.

With reference to FIG. 2 for a board device of a single board computer in accordance with an embodiment of the present invention, a processor accommodated in the processor frame 63 is attached to the cooling base 58 through a first thermal conductive sheet 61, and a second thermal conductive sheet 62.

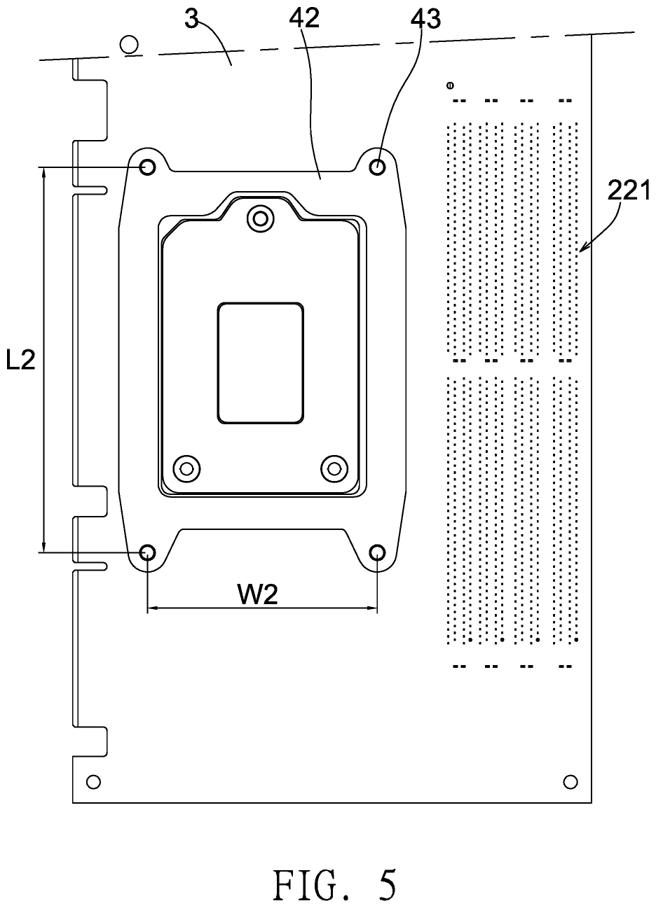

With reference to FIGS. 2, 3 and 5 for a board device of a single board computer 1 in accordance with an embodiment of the present invention, the bottom frame portion 4 further comprises: a bottom frame member 42 with a hollow inner side and four locking holes 43; a cushion frame 45 with a hollow inner side and four through holes 44, and an end of each locking hole 43 being configured to be corresponsive to the respective through hole 44 and the respective locking hole 43; and four clips 41, each disposed between the baseboard 3 and the cushion frame 45, wherein after each locking member 51 is passed through the baseboard 3, each locking member 51 is clamped by a clip 41, and an end of each locking member 51 is passed through the respective through hole 44 and then coupled to the respective locking hole 43.

With reference to FIGS. 1, 2, 3, 4 and 5 for a board device of a single board computer 1 in accordance with an embodiment of the present invention, by a soldering hole 221 of the baseboard 3, the lower end of the small outline dual in-line memory module 2 is soldered to the back area of the baseboard 3, and the interval between the through hole 44 has a second length L2 and a second width W2, and the interval between the locking holes 43 has the second length L2 and the second width W2, and the locking member 51 is provided for locking the bottom frame member 42 and the cushion frame 45 to the back area of the baseboard 3, and a gap is formed between the bottom frame member 42 and the soldering hole 221 of the small outline dual in-line memory module 2.

The processor frame 63 of the present invention has a size complying with the size specification of the LGA 1200 processor socket, and the processor frame 63 of the invention can support the processors of the LGA 1200 processor socket such as Core i7, Corei9, etc.

In the specification of the LGA 1200 processor socket, the interval between the seat holes of the cooling base has a first length L1: 75 mm and a first width W1: 756 mm.

In the size specification of the LGA 2011 processor socket, the interval between the seat holes 57 of the cooling base has a second length L2: 94 mm and a second width W2: 56 mm. The size of the cooling module 5 of the present invention matches the size of the cooling module of the corresponding LGA 2011 processor socket. In other words, the interval between the seat holes 57 of the cooling base of the cooling module 5 of the present invention also has specification of a second length L2: 94 mm and a second width W2: 56 mm.

In view of the description above, the interval between the seat holes 57 of the cooling base 58 of the present invention is the second width W2: 56 mm, which is smaller than the interval between the seat holes of the cooling base 78 of the prior art (or the first width W1 is 75 mm), so that the cooling base 58 of the present invention has a size that does not interfere with the four small outline dual in-line memory modules 2, or interfere with the edge of the soldering holes 221 soldered to the back area of the baseboard 3. The present invention can overcome the size issue of the cooling base 78 of the prior art that interferes with the four small outline dual in-line memory modules 2. The present invention saves the design cost and development time of the customized cooling module, and the invention can be applied immediately to PICMG products of different specifications.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. It is noteworthy that the embodiments and figures disclosed herein are to be considered illustrative rather than restrictive.

1. A board device of a single board computer, comprising:
a baseboard with a front area and a back area, a width of the baseboard being 126.39 mm;
at least one small outline dual in-line memory module, installed in the front area of the baseboard;
a processor frame, installed in the front area of the baseboard, and having a size complying with a size specification of a LGA 1200 processor socket, the size of the processor socket being 42.5 mm×42.5 mm;
a cooling module, combined into the processor frame, and installed in the front area of the baseboard, and the cooling module having a size corresponding to a size specification of a cooling module of a LGA 2011 processor socket, the size of a base of the cooling module being 70 mm×107 mm; and
a bottom frame portion disposed in the back area of the baseboard;
wherein the baseboard has 4 board holes; the cooling module further comprises a cooling base, and 4 seat holes formed at four inner corners of the cooling base respectively, and 4 locking members;
each locking member is configured to correspond to a respective board hole of the baseboard, and the respective board hole of the baseboard is configured to correspond to a respective seat hole of the cooling module; and
the 4 locking members are passed through the 4 board holes of the baseboard respectively to lock the bottom frame portion to the cooling base of the cooling module, and the 4 board holes have a hole distance complying with a hole distance specification of the four seat holes of the cooling module of the LGA 2011 processor socket, and the hole distance of the four seat holes for a bottom frame member is 94 mm×56 mm.

2. (canceled)

3. The board device of the single board computer according to claim 1, wherein the at least one small outline dual in-line memory module further comprises:
a memory card; and
a slot, formed in the front area of the baseboard, and provided for plugging the memory card therein.

4. The board device of the single board computer according to claim 3, wherein the cooling module further comprises:
a fin module, coupled to the cooling base;
a fan, coupled to the fin module; and
4 springs and 4 washers;
and each locking member is configured to correspond to a respective spring and a respective washer, and pass through the respective spring and the respective washer and then through the respective seat hole and the respective board hole for elastically fixing the cooling module.

5. The board device of the single board computer according to claim 4, wherein the at least one small outline dual in-line memory module has a first edge disposed adjacent to the cooling base, and the 4 locking members are provided for locking the cooling base in the front area of the baseboard, and a gap is formed between the cooling base and the first edge of the small outline dual in-line memory module.

6. The board device of the single board computer according to claim 4, wherein a processor accommodated in the processor frame is attached to the cooling base through a first thermal conductive sheet and a second thermal conductive sheet.

7. The board device of the single board computer according to claim 4, wherein the bottom frame portion further comprises:
a bottom frame member, with a hollow inner side, and having 4 locking holes;
a cushion frame, with a hollow inner side, and having 4 through holes, and an end of each locking hole being configured to correspond to a respective through hole; and
4 clips, installed between the baseboard and the cushion frame, wherein after each locking member is passed through the baseboard, each locking member is clamped by a clip of the 4 clips, and after an end of each locking member is passed through the respective through hole, the locking member is configured to correspond to the respective locking hole.

8. The board device of the single board computer according to claim 5, wherein by a soldering hole of the baseboard, a lower end of the at least one small outline dual in-line memory module is soldered to the back area of the baseboard, the 4 locking members are provided for locking the bottom frame member to the back area of the baseboard, and a gap is formed between the bottom frame member and the soldering hole of the at least one small outline dual in-line memory module.
